(19) United States
(12) Patent Application Publication
(10) Pub. No.: US 2008/0264371 A1
(43) Pub. Date: Oct. 30, 2008

(54) LASER IGNITION DEVICE AND LASER-IGNITION INTERNAL COMBUSTION ENGINE

(76) Inventors: Akikazu Taido, Nagoya-shi (JP); Tomoaki Kato, Nagoya-shi (JP)

Correspondence Address: STITES & HARBISON PLLC, 1199 NORTH FAIRFAX STREET, SUITE 900, ALEXANDRIA, VA, 22314, US

(21) Appl. No.: 12/109,753

(22) Filed: Apr. 25, 2008

(30) Foreign Application Priority Data
Apr. 26, 2007 (JP) P2007-116417

(51) Int. Cl. F02P 23/04

(52) U.S. Cl. 123/143 B; 102/201

(57) ABSTRACT

A laser ignition device for irradiating and condensing laser beams in a combustion chamber of an internal combustion engine so as to ignite fuel particles within the combustion chamber, includes: a laser beam generating unit for emitting the laser beams; and a condensing optical member for guiding the laser beams into the combustion chamber such that the laser beams are condensed in the combustion chamber, wherein the laser beam generating unit comprises a Beam Parameter Product (BPP) laser beam generating unit which emits the laser beams with a BPP value of no more than 20 mm·mrad (radius·half angle).

### CROSS-REFERENCE TO RELATED APPLICATIONS

This application claims the benefit of Japanese Patent Application JP 2007-116417, filed Apr. 26, 2007, the entire content of which is hereby incorporated by reference, the same as if set forth at length.

### BACKGROUND OF THE INVENTION

1. Field of the Invention

The present invention relates to a laser ignition device, which condenses laser beams into a combustion chamber of the internal combustion engine so as to ignite fuel particles, and a laser-ignition internal combustion engine including the laser ignition device.

2. Description of the Related Art

In addition to a spark plug which is used for ignition of an internal combustion engine, a laser ignition device is proposed, which condenses laser beams emitted from a laser oscillator into a combustion chamber of an engine so as to ignite a gas mixture (including fuel particles) within the combustion chamber.

In Japanese Unexamined Patent Application Publication No. 2006-329186 (corresponding to US2006/0243238A1), the pressure within the combustion chamber is calculated to enhance the energy of the laser beams. Then, based on the calculated pressure, a current is supplied to the laser oscillator so as to increase the output energy of the laser beams. However, the quality of laser beams, for example, the spread angle, has not been specifically described.

### SUMMARY OF THE INVENTION

Among the advantages of the present invention are that a laser ignition device incorporating the invention stably ignites fuel particles and a laser-ignition type internal combustion engine incorporating the invention properly combusts fuel particles.

According to an aspect of the invention, a laser ignition device for irradiating and condensing laser beams in a combustion chamber of an internal combustion engine so as to ignite fuel particles within the combustion chamber, includes a laser beam generating unit for emitting the laser beams; and a condensing optical member for guiding the laser beams into the combustion chamber such that the laser beams are condensed in the combustion chamber. The laser beam generating unit includes a Beam Parameter Product (BPP) laser beam generating unit which emits the laser beams with a BPP value of 20 mm·mrad (radius·half angle) or less (i.e. no more than 20 mm·mrad).

In the laser ignition device, the laser beam generating unit which emits laser beams with a small BPP value is used. Therefore, although a condensing optical member having a small lens diameter and a long focal distance is used, the laser beams can be properly condensed. Accordingly, the laser beams can be condensed on a position separated from the condensing optical member in the combustion chamber of the internal combustion engine, for example, in the vicinities of the center of the combustion chamber such that a larger quantity of fuel particles can be ignited at a proper position. As a result, in the internal combustion engine using the laser ignition device according to the invention, it is possible to obtain a more proper combustion characteristic.

Meanwhile, when the laser beams are irradiated on the fuel particles, some fuel particles having received high energy among the fuel particles become high-temperature plasma (laser breakdown), and the fuel particles surrounding the plasma are consecutively ignited and combusted by the high-temperature heat of the plasma. At this time, as a quantity of fuel particles becoming plasma increase, the range of the plasma broadens, and the fuel particles surrounding the plasma increase. Then, a larger quantity of fuel particles is ignited, and the combustion quickly propagates. The present inventors have found that when laser beams with a small BPP value are used, the generation range of plasma is wider than when laser beams with a relatively large BPP value are used. Accordingly, as the laser ignition device of the invention is used, the ignition and combustion can be quickly and stably realized.

The BPP value is one of parameters which indicate the quality of laser beams and is represented by the product of a laser beam radius ω(mm) at a focus and the spread half angle θ(mrad) of laser beams.

BPP=ω·θ(mm·mrad) (1)

As for the laser beam generating unit, a laser beam generating unit may be used, which is capable of emitting laser beams having a BPP value of 20 mm·mrad (radius·half angle) or less. Further, a laser beam generating unit may be used, which is suitable for igniting fuel particles, that is, which can realize a wavelength, the frequency of repetitive pulse and so on. For example, a YAG laser (1.064 μm) or the like can be utilized.

As for the condensing optical member, a condensing optical member which can guide laser beams into a combustion chamber such that the laser beams are condensed in the combustion chamber may be used. Preferably, a condensing optical member which has excellent heat resistance and vibration proof and does not generate a variation in an optical system over time is used. A lens or mirror can be used as the condensing optical member, and an optical fiber formed of quartz or the like or a bundle of optical fibers may be used in a portion of the lens or mirror. Further, an optical fiber having an end surface processed in a convex-lens shape or concave-lens shape may be used.

In the above-described laser ignition device, the condensing optical member may be a distribution-type condensing optical member which condenses the laser beams in the combustion chamber such that the laser beams are distributed in a line shape or dotted shape. Since the laser beams can be condensed in a line shape or dotted shape within the combustion chamber, the fuel particles can be ignited across a wide range within the combustion chamber. Therefore, the fuel particles can be uniformly and quickly combusted. In the internal combustion engine using the laser ignition device of the invention, it is possible to obtain a more proper combustion characteristic.

As for a method of condensing laser beams in a dotted shape, a method can be exemplified in which a plurality of laser beams are previously divided by a half mirror or diffraction grating, and the divided laser beams are guided into the combustion chamber by an optical fiber or lens for laser beams so as to be condensed. Alternatively, another method can be exemplified in which while laser beams are incident on a bundle of optical fibers, the laser beams are guided into the combustion chamber so as to be condensed. Further, a method may be used, in which a laser beam is guided to the vicinity of the combustion chamber through an optical fiber or lens and is then divided into a plurality of laser beams immediately before being emitted from the condensing optical member such that the plurality of laser beams are emitted into the combustion chamber so as to be respectively condensed.

In the above-described ignition device, a movement distance of a focal position of the laser beams within the combustion chamber is no less than (i.e. equal to or more than) 40 mm. Since the movement distance of the focal position of the laser beams within the combustion chamber is equal to or more than 40 mm, the focal position of the laser beams can be significantly moved inside the combustion chamber. That is, a region within the combustion chamber broadens where the laser beams are focused. Therefore, although the density distribution of fuel particles within the combustion chamber is so non-uniform that the focal position of laser beams suitable for ignition and combustion deviates, it is possible to adjust the focus of the laser beams to a proper position, thereby obtaining a proper combustion characteristic. Accordingly, it is possible to widen the width of an operation condition for realizing a proper combustion characteristic.

According to another aspect of the invention, a laser-ignition internal combustion engine includes an internal combustion engine including a combustion chamber; and a laser ignition device which irradiates and condenses laser beams in the combustion chamber of the internal combustion engine so as to ignite fuel particles within the combustion chamber. The laser ignition device includes: a laser beam generating unit for emitting the laser beams; and a condensing optical member for guiding the laser beams into the combustion chamber such that the laser beams are condensed in the combustion chamber. The laser beam generating unit comprises a BPP laser beam generating unit which emits the laser beams with a BPP value of 20 mm·mrad (radius·half angle) or less (i.e. no more than 20 mm·mrad).

In the exemplary laser-ignition internal combustion engine, the laser beam generating unit emits laser beams with a small BPP value. Therefore, although a condensing optical member having a small lens diameter and a long focal distance is used, the laser beams can be properly condensed. Accordingly, the laser beams can be condensed on a position separated from the condensing optical member in the combustion chamber, for example, in the vicinities of the center of the combustion chamber such that a larger quantity of fuel particles can be ignited at a proper position. As a result, it is possible to obtain a more proper combustion character.

In the above-described laser-ignition internal combustion engine, the fuel particles are introduced into the combustion chamber in a particle group movement path. The condensing optical member provides that the laser beams guided into the combustion chamber by the optical member pass through the particle group movement path. Since the laser beams with a small BPP value pass through the particle group movement path of the fuel particle group within the combustion chamber, a large quantity of fuel particles can be quickly ignited and combusted in the internal combustion engine.

In addition to the characteristics of the condensing optical member such as a focal distance, an opening diameter and so on, the positional relationship with other members, such as the propagation direction of laser beams or the position of focus, is included in the characteristics of the condensing optical member.

Further, as for a method of introducing fuel particles, a method in which an injector capable of injecting fuel particles into a combustion chamber or intake manifold at high pressure is used, or a method in which a carburetor capable of mixing and inputting fuel particles into a suction hole of a combustion chamber is used.

In the above-described laser-ignition internal combustion engine, the condensing optical member is a distribution-type condensing optical member which condenses the laser beams in the combustion chamber such that the laser beams are distributed in a line shape or dotted shape. Since the laser beams can be condensed in a line shape or dotted shape within the combustion chamber, the fuel particles can be ignited across a wide range within the combustion chamber. Therefore, a gas mixture including the fuel particles can be uniformly and quickly combusted, which makes it possible to obtain a more proper combustion characteristic.

In the above-described laser-ignition internal combustion engine, the combustion chamber includes a combustion chamber surface having an irradiated surface portion made of metal, and the condensing optical member condenses the laser beams on the irradiated surface portion.

In the exemplary laser-ignition internal combustion engine, the laser beam generating unit emits laser beams with a small BPP value. Therefore, although a condensing optical member having a long focal distance is used, it is possible to properly condense the laser beams on the irradiated surface. Accordingly, although the irradiated surface is separated from the emission position of the laser beams, the laser beams can be properly focused on the irradiated surface, which makes it possible to obtain a proper combustion characteristic.

That is, when the laser beams are condensed and irradiated on the metal surface (irradiated surface), high-temperature plasma (hereinafter, simply referred to as plasma) caused by ionized metal vapor is blown up, and the fuel particles coming in contact with the plasma are ignited and combusted by the high-temperature heat of the plasma. At this time, as the quantity and range (width or height) of the blown plasma increases and broadens, a quantity of fuel particles coming in contact with the plasma increases. Then, a larger quantity of fuel particles is ignited, and the combustion quickly propagates. The present inventors have found that when laser beams with a small BPP value are used, the range (blown range) of the plasma is wider than when laser beams with a relatively large BPP value are used. As the laser beams propagates, the spread angle thereof decreases. Therefore, a smaller spot (high energy density) can be obtained. Accordingly, it is possible to ignite even the fuel particles in the vicinities of the center of the combustion chamber, that is, in a position separated from the irradiated surface.

As for the metal forming the irradiated surface, a metal or alloy is preferably used, which is capable of generating plasma through laser beams and has heat resistance as a portion of the combustion chamber surface. For example, a Ni-based heat-resistant allow such as Inconel (trademark) alloy or precious metal such as Pt or Ir may be used.

In the above-described laser-ignition internal combustion engine, the internal combustion engine further has a piston which reciprocates in a cylinder bore of the internal combustion engine. The piston includes a piston combustion-chamber side surface forming a portion of the combustion chamber surface, the piston combustion-chamber side surface including the irradiated surface portion. The condensing optical member condenses the laser beams on the irradiated surface portion when the piston is positioned at least close to a top dead center position.

In the laser-ignition internal combustion engine of the invention, the condensing optical member has an optical characteristic that condenses the laser beams on the irradiated surface. Therefore, when the laser beams are irradiated on the irradiated surface of the piston combustion-chamber side surface at timing that the piston is positioned at the top dead center or in the vicinity of the top dead center, plasma is blown up from the irradiated surface. Therefore, the fuel particles can be ignited. Further, in the laser-ignition internal combustion engine of the invention, since the laser beams with a small BPP value are used, the plasma is more highly and widely blown up than when laser beams with a large BPP value are used. Accordingly, even the fuel particles in the vicinities of the center of the combustion chamber can be ignited, which makes it possible to obtain a more proper combustion characteristic. Further, since the laser beams with a small BPP value are used, the focal distance of the condensing optical member can be lengthened, which makes it possible to enlarge a Rayleigh length where the laser beams are schematically condensed. The Rayleigh length corresponds to a distance in an optical-axis direction when the size of a spot becomes √2 times the size of the spot at a focus. Therefore, although the irradiation timing of the laser beams is changed, the plasma can be reliably discharged from the irradiated surface of the piston, and the timing can be easily adjusted.

In the above-described laser-ignition internal engine, a movement distance of the focal position of the laser beams within the combustion chamber is equal to or more than 40 mm (i.e., no less than 40 mm). Since the movement distance of the focal position of the laser beams within the combustion chamber is equal to or more than 40 mm, the focal position of the laser beams can be significantly moved inside the combustion chamber. That is, a region within the combustion chamber broadens, where the laser beams are focused. Therefore, although the density distribution of fuel particles within the combustion chamber is so non-uniform that the focal position of laser beams suitable for ignition and combustion deviates, it is possible to adjust the focus of the laser beams to a proper position, thereby obtaining a proper combustion characteristic. Accordingly, it is possible to widen the width of an operation condition for realizing a proper combustion characteristic.

In the above-described laser-ignition internal engine, the particle group movement path extends in a first direction and the laser beams are irradiated in a second direction, and the first and second directions are separated by an angle of between 30 and 150 degrees. Therefore, although the injection timing of fuel deviates from predetermined timing due to an effect caused by a variation in fuel injection control or the like, the laser beams cross the vicinities of a proper position for ignition and combustion with respect to the particle group movement path of the fuel particle group. Accordingly, it is possible to reliably ignite the fuel particles.

Other features and advantages of the invention with be set forth in, or apparent from, the detailed description of exemplary embodiments of the invention found below.

### BRIEF DESCRIPTION OF THE DRAWINGS

FIG. 1 is a schematic view of a combustion chamber of an internal engine according to a first exemplary embodiment of the invention.

FIG. 2A is a schematic view of a laser ignition device according to the first exemplary embodiment of the invention.

FIG. 2B is an expanded cross-sectional view of a condensing optical member included in the laser ignition device of FIG. 2A.

FIG. 3 is a graph showing the relationship between the area of plasma and the BPP value of irradiated laser beams according to the first exemplary embodiment of the invention.

FIG. 4 is a schematic view of a combustion chamber of an engine according to a first modification of the first exemplary embodiment of the invention.

FIG. 5A is a an expanded cross-sectional view of a condensing optical member included in a laser ignition device of FIG. 4.

FIG. 5B is a cross-sectional view taken along line A-A line of FIG. 5A.

FIG. 6 is a schematic view of a combustion chamber of an engine according to a second modification of the first exemplary embodiment of the invention.

FIG. 7 is an expanded cross-sectional view of a condensing optical member included in the laser ignition device according to the second modification of the first exemplary embodiment of the invention.

FIG. 8 is a schematic view of a combustion chamber of an engine according to a second exemplary embodiment of the invention.

FIG. 9 is a graph showing the relationship between the area of plasma and the BPP value of irradiated laser beams according to the second exemplary embodiment of the invention.

### DESCRIPTION OF REFERENCE NUMERALS

Reference numerals used to identify various structural features in the drawings include the following.
1, 101, 201, 301: ENGINE (LASER-IGNITION INTERNAL COMBUSTION ENGINE)
2: INTERNAL COMBUSTION ENGINE
20, 120, 220, 320: LASER IGNITION DEVICE
21, 121, 221, 231: CONDENSING OPTICAL MEMBER
28: LASER BEAM GENERATOR (LASER BEAM GENERATING UNIT)
50: COMBUSTION CHAMBER
51: COMBUSTION CHAMBER SURFACE
60: FUEL PARTICLE
61: GROUP (OF FUEL PARTICLES)
61a: PARTICLE GROUP MOVEMENT PATH
340: PISTON
343: HEAD SURFACE (PISTON COMBUSTION-CHAMBER SURFACE)
381: IRRADIATED SURFACE
LB1: LASER BEAM
LB2: LASER BEAM
LB3: LASER BEAM
LB4: LASER BEAM

### DETAILED DESCRIPTION OF EXEMPLARY EMBODIMENTS OF THE INVENTION

### 1. First Exemplary Embodiment

Hereinafter, a first exemplary embodiment of the present invention will be descried with reference to the accompanying drawings.

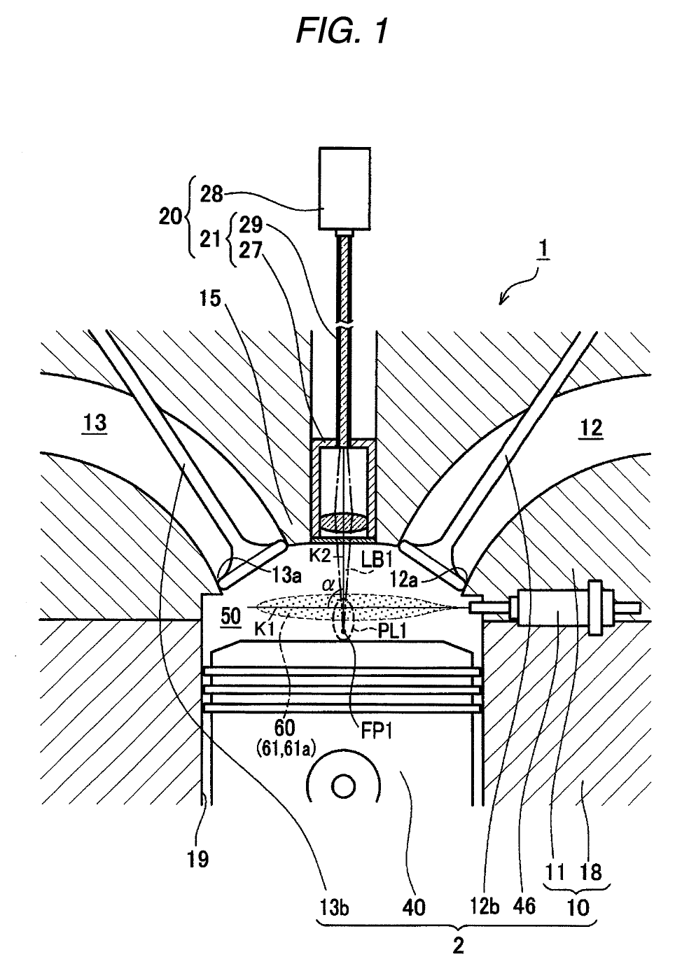

FIG. 1 is a schematic view of the vicinities (the upper portion of a cylinder) of a combustion chamber of a laser-ignition internal combustion engine 1 (hereinafter, refer to as an engine) according to the first exemplary embodiment of the invention. The engine 1 includes an internal combustion engine 2 composed of a cylinder 10, a piston 40, a suction valve 12b, an exhaust valve 13b, and an injector 46 and a laser ignition device 20.

In the internal combustion engine 2, the piston 40 is slidably coupled to a cylinder bore 19 formed in a cylinder block 18 of the cylinder 10, and the upper space of the cylinder bore 19 forms the combustion chamber 50.

A suction hole 12a of a suction pipe 12 connected to the combustion chamber 50 is opened and closed at predetermined timing by a valve portion of the suction valve 12b attached to a cylinder head 11 which covers the cylinder block 18. Similarly, a suction hole 13a of an exhaust pipe 13 connected to the combustion chamber 50 is opened and closed at predetermined timing by a valve portion of the exhaust valve 13b attached to the cylinder head 11. The suction valve 12b and the exhaust valve 13b are driven by driving mechanisms (not shown), respectively. In the cylinder block 18, the injector 46 is attached in the vicinity of the suction valve 12b. The injector 46 is connected to a fuel tank through a fuel pipe (not shown) so as to inject fuel particles 60 into the combustion chamber 50. A group 61 of the injected fuel particles 60 moves along a particle group movement path 61a.

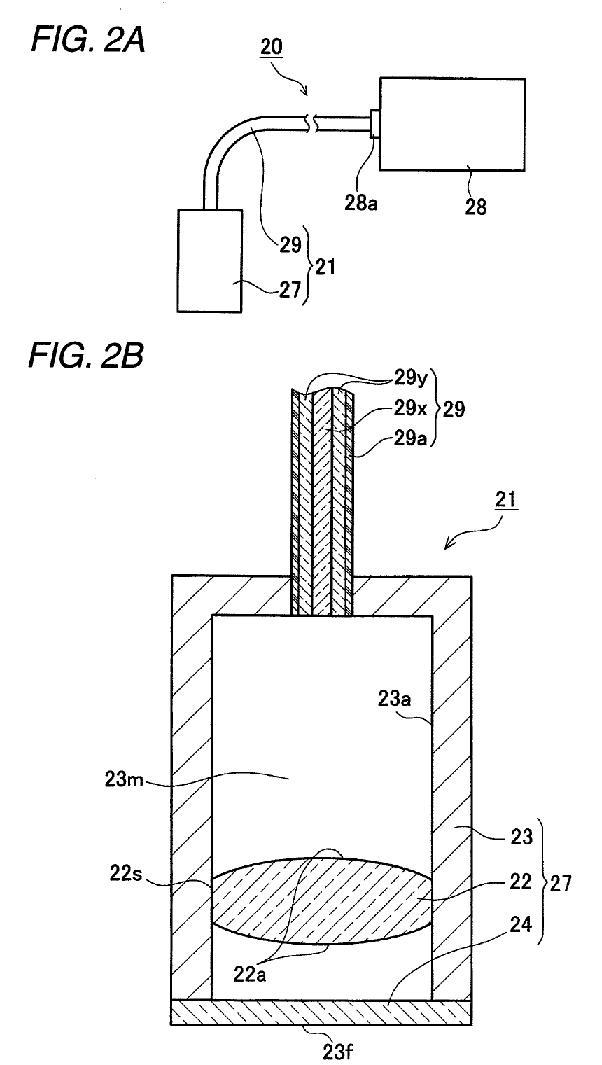

Next, the laser ignition device 20 attached to the top portion 15 of the cylinder block 11 will be described with reference to FIGS. 2A and 2B. The laser ignition device 20 includes a laser beam generator 28 and a condensing optical member 21 composed of an optical fiber 29 and a condenser 27.

The laser beam generator 28 is a YAG laser generator and is controlled by an engine control unit (which is not shown and is referred to as ECU) so as to emit laser beams LB1 of which the cross-section is circular. Further, the laser beams LB1 are incident on the condenser 27 through the optical fiber 29 connected to an emission portion 28a of the laser beam generator 28.

The optical fiber 29 has a core 29x formed in the shaft center thereof, the core 29x being made of quartz glass. The core 29x is surrounded by a clad 29y which has a different refractive index from the core 29x and is made of quartz glass. The clad 29y is covered by a resin cover 29a. The laser beams LB1 emitted from the laser beam generator 28 pass through the core 29x so as to be incident on the condenser 27.

The condenser 27 has a cylindrical casing 23, a convex lens 22, and a protective glass 24. Among them, a hollow portion 23m of the casing 23 constructs a path for the laser beams LB1, and a lens side surface 22s of the convex lens 22 is bonded to the inner side surface 23a of the casing 23 such that the convex lens 22 is fixed. Further, the protective glass 24 forms a front end surface 23f of the casing 23.

The convex lens 22 has lens surfaces 22a formed on both surfaces thereof and condenses the laser beams LB1 incident through the hollow portion 23m of the casing 23. Further, the condensed laser beams LB1 are emitted through the heat-resistant protective glass 24 which is formed in a circular plate shape.

The engine 1 repeatedly performs a cycle composed of a suction stroke, a compression stroke, an explosion stroke, and an exhaust stroke. Here, the suction and compression strokes will be described.

In the suction stroke, the suction valve 12b of the cylinder head 11 is opened, and the exhaust valve 13b is closed. Then, as the piston 40 is pulled downward inside the cylinder, the air is sucked into the combustion chamber 50 from the suction valve 12b.

In the compression stroke, the suction valve 12b and the exhaust valve 13b are closed. Then, the piston 40 is pushed upward to reduce the volume of the combustion engine 50 such that the air within the combustion chamber 50 is compressed. In the middle period of the compression stroke, misty fuel particles 60 are injected toward the compressed gas from the injector 46. Then, the laser beams LB1 is irradiated by the laser ignition device 20 at such timing that the piston 40 is positioned at the top dead center or just before the top dead center. Then, the fuel particles 60 are ignited. Specifically, the fuel particles 60 onto which the high-energy laser beams LB1 are irradiated are ignited so as to become plasma PL1 (refer to FIG. 1).

A focal position FP1 of the laser beams LB1 is set to the vicinities of the center of the combustion chamber 50 by adjusting the position or focal distance of the convex lens 22 (refer to FIG. 1). Accordingly, the irradiated laser beams LB1 pass through the particle group movement path 61a of the group 61 of the fuel particles 60 so as to be condensed at the focal position FP1.

In the engine 1 according to the first exemplary embodiment 1, the laser beam generator 28 is used, which emits the laser beams LB1 with a small BPP value. Therefore, although the convex lens 22 having a small lens diameter and a long focal distance is used, the laser beams LB1 can be properly condensed on a tiny spot. Therefore, the focal position FP1 within the combustion chamber 50 can be set to a position separated from the convex lens 22, for example, in the vicinities of the center of the combustion chamber 50. The fuel particles 60 can be ignited at a proper position inside the combustion chamber 50, for example, in the vicinities of the center of the combustion chamber 50. Further, since the laser beams LB1 with a small BPP value are passed through the particle group movement path 61a, it is possible to ignite a large quantity of fuel particles 60. Accordingly, a more proper combustion characteristic can be obtained. Further, since the movement distance of the focal position of the laser beams LB1 within the combustion chamber 50 is equal to or more than 40 mm, a region within the combustion chamber 50 broadens, where the laser beams LB1 are focused. Therefore, it is possible to widen the width of an operation condition of the engine 1 for realizing a proper combustion characteristic. Further, an angle α formed by the direction K1 of the particle group movement path 61a and the irradiation direction K2 of the laser beams LB1 ranges from 30 to 150° C. (in this exemplary embodiment, α=90° C.). Therefore, the laser beams LB1 cross the particle group movement path 61a of the fuel particle group 61, which makes it possible to reliably ignite the fuel particles 60.

Meanwhile, the present inventors carried out an experiment of verifying the relationship between a generated amount of plasma and a difference in BPP value of the laser beams LB1 by using the laser ignition device 20 according to the first exemplary embodiment.

First, a chamber pressurized at 0.1 MPa was set to a combustion chamber of an engine, and an injector capable of continuously injecting fuel particles into the combustion chamber was provided. Further, a focal position FP1 was set outside a fuel particle group such that laser beams pass through the fuel particle group. Then, the laser beams were emitted. At this time, plasma generated by the emission of the laser beams was photographed by a camera from outside the chamber, and the area of the plasma was quantitatively evaluated.

In this experiment, a laser beam generator which emits laser beams LB1 with a total of 9 kinds of BPP values, that is, 2, 4, 8, 10, 16, 25, 40, 80, and 100 mm·mrad (radius·half angle) toward the convex lens 22 was used as the laser beam generator 28 so as to carry out experiments for the respective values. Further, the injection pressure of the injector was set to 0.25 MPa, an injection rate was set to 250 ml/min, an injection angle was set to 25 degrees, and high-octane gasoline was used as the fuel. Further, a focal position within the injection space and a spot diameter at the focal position were set to be identical, and the laser energy of respective YAG lasers to be used was set to 30 mJ.

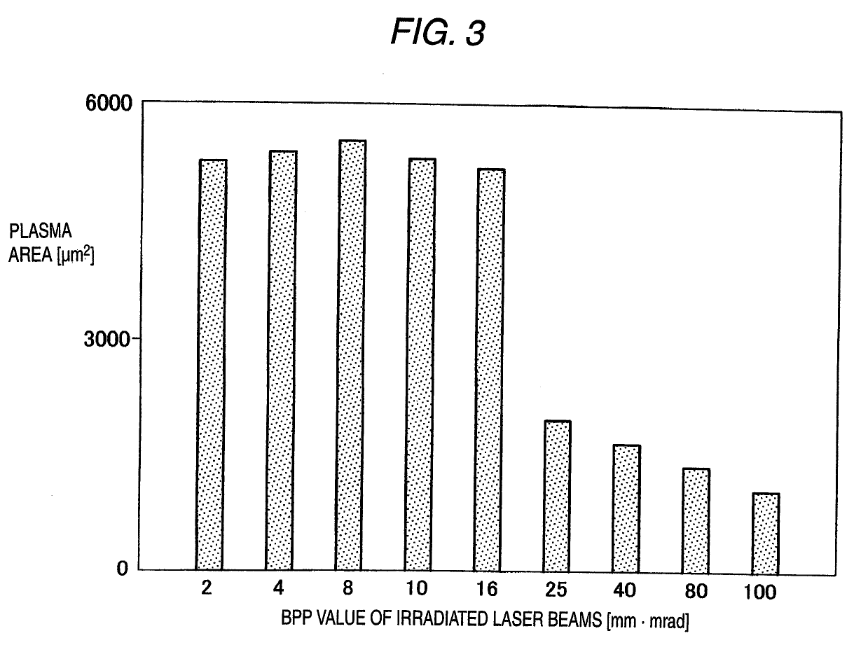

FIG. 3 is a graph showing the relationship between the BPP value of the used laser beams and the area of the generated plasma. According to the graph, when laser beams LB1 having a larger BPP value than 20 mm·mrad (radius·half angle) are used, the area of plasma is about 2000 μm². On the contrary, it is judged that when laser beams LB1 having a smaller BPP value than 20 mm·mrad (radius·half angle) are used, the area of plasma can be considerably increased to 5000 μm² or less.

Meanwhile, when laser beams are irradiated onto fuel particles, some fuel particles having received high energy among the fuel particles become high-temperature plasma (laser breakdown), and the fuel particles surrounding the plasma are consecutively ignited and combusted by the high-temperature heat of the plasma. At this time, as the fuel particles becoming plasma increase, the range of plasma further broadens, and fuel particles surrounding the plasma also increase. Accordingly, a larger quantity of fuel particles is ignited, and the combustion quickly propagates.

According to the effect of the above-described experiment, when the laser beams having a BPP value of 20 mm·mrad (radius·half angle) or less are used, the generation range of the plasma is much wider than when laser beams having a larger BPP value than 20 mm·mrad (radius·half angle) are used. Accordingly, it is judged that when the laser beam generator 28 which emits laser beams LB1 having a BPP value of 20 mm·mrad (radius·half angle) or less is used in the laser ignition device 20 according to the first exemplary embodiment, the ignition and combustion can be more quickly and stably realized.

### a. First Modification of the First Exemplary Embodiment

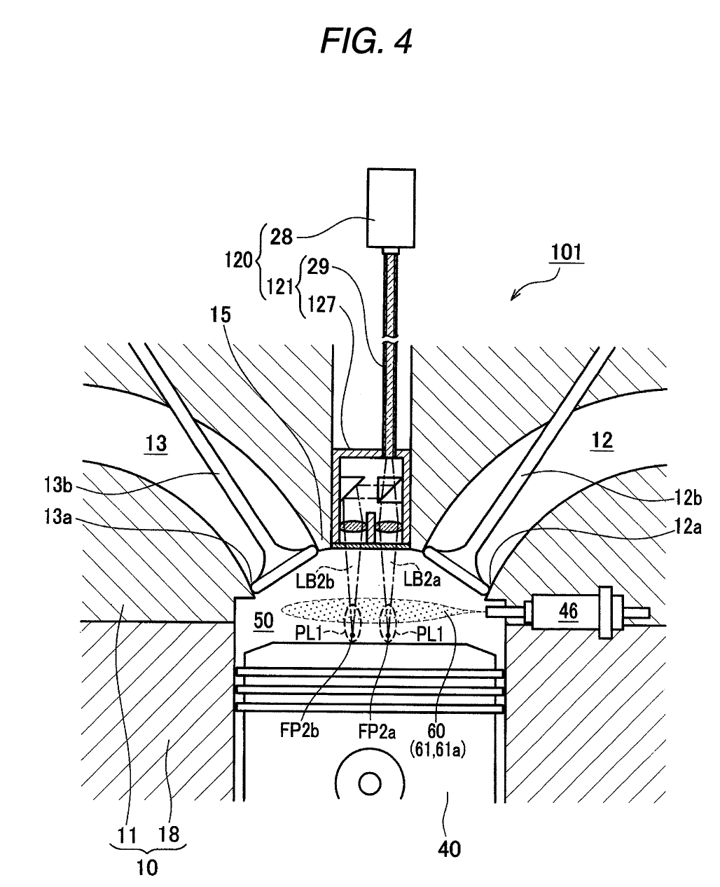

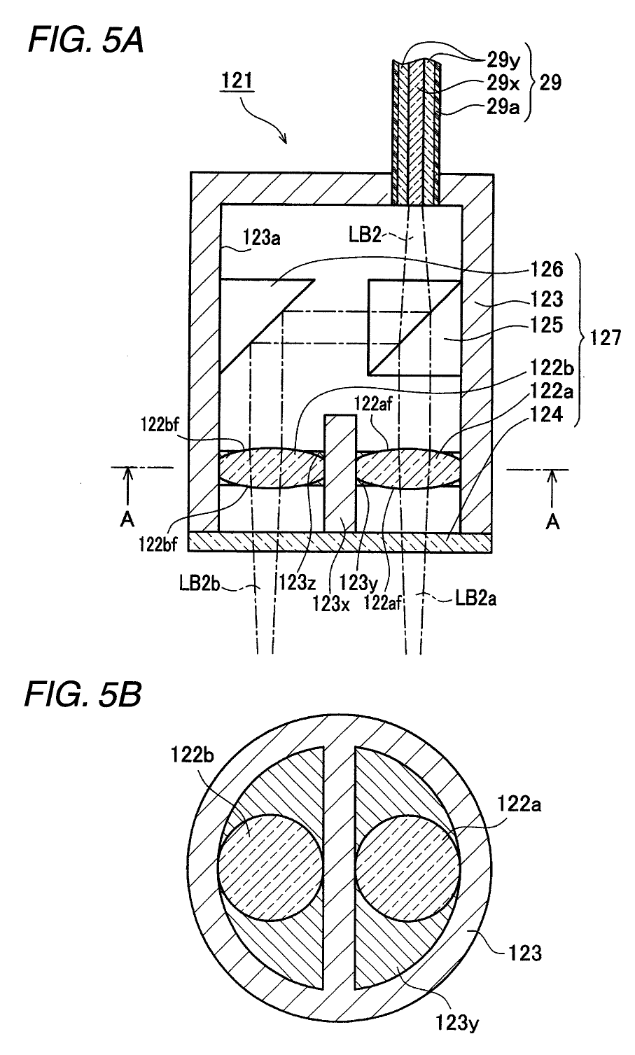

Next, a first modification of the first exemplary embodiment will be described with reference to FIGS. 4 and 5.

In the first exemplary embodiment, the laser beams LB1 are condensed on one point. In the first modification, however, a split mirror 125 is used to divide laser beams LB2 into two parts such that the divided laser beams LB2 are condensed on two points.

Therefore, the descriptions will be focused on different constructions from those of the first exemplary embodiment. Further, the descriptions of the same constructions as those of the first exemplary embodiment are omitted or simplified, but the same operational effect will be obtained for the same constructions. Further, like reference numerals will be attached to the same components.

A laser ignition device 120 of an engine 101 according to the first modification of the invention has a laser beam generator 28 which emits laser beams LB2 with a BPP value of 20 mm·mrad (radius·half angle) or less. In addition, the laser ignition device 120 includes an optical fiber 29 and a condenser 127 which compose a distribution-type condensing optical member 121. The condenser 127 includes a cylindrical casing 123, two convex lenses 122a and 122b, a protective glass 124, a split mirror 125, a partition wall 123x, a lens-lower-portion fixing plate 123y, a lens-upper-portion fixing plate 123z, and a reflecting mirror 126 (refer to FIG. 5A).

The split mirror 125 is held on the inner side surface 123a of the casing 123, and splits laser beams LB2 incident from the optical fiber 29 into first laser beams LB2a which propagate straight and second laser beams LB2b which are reflected so as to be incident on the reflecting mirror 126. Further, the reflecting mirror 126 is also held on the inner side surface 123a of the casing 123, and reflects the second laser beams LB2b from the split mirror such that the laser beams LB2b are incident on the second convex lens 122b.

The first convex lens 122a is interposed and fixed between the lens-lower-portion fixing plate 123y and the lens-upper-portion fixing plate 123z which are disposed between the partition wall 123x and the inner side surface 123a of the casing 123. Both lens surfaces 122af of the first convex lens 122a have an area which is exposed from the lens-lower fixing plate 123y and the lens-upper-portion fixing plate 123z, respectively, the area being larger than the light path of the first laser beams LB2a passing through the lens surfaces 122af (refer to FIG. 5B). Similar to the first convex lens 122a, the second convex lens 122b is also interposed and fixed between the lens-lower-portion fixing plate 123y and the lens-upper-portion fixing plate 123z in a state where both lens surfaces 122bf thereof are exposed. Further, the first convex lens 122a condenses the first laser beams LB2a incident through the split mirror 125, and the second convex lens 122b condenses the second laser beams LB2b incident through the reflecting mirror 126. Further, the condensed laser beams LB2a and LB2b are emitted through the protective glass 124.

In the laser ignition device 120 and the engine 101 according to the first modification, the first and second laser beams LB2a and LB2b can be condensed on focal positions FP2a and FP2b, respectively, in the vicinities of the center of the combustion chamber 50 (refer to FIG. 4).

As such, in the laser ignition device 120 and the engine 101 according to the first modification, the laser beams LB2 can be condensed on two points in the combustion chamber 50. Thus, fuel particles 60 can be ignited across a wide range inside the combustion chamber 50. Therefore, the fuel particles 60 can be more uniformly and rapidly ignited. Further, in the engine 101 using the laser ignition device 120 according to the first modification, it is possible to obtain a more proper combustion characteristic.

### b. Second Modification of the First Exemplary Embodiment

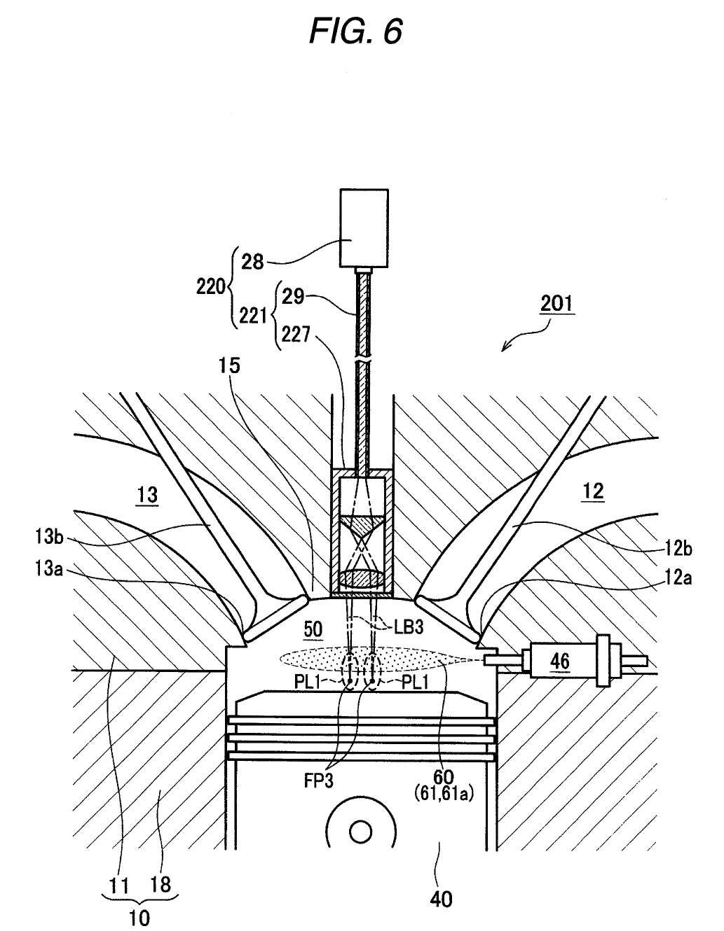

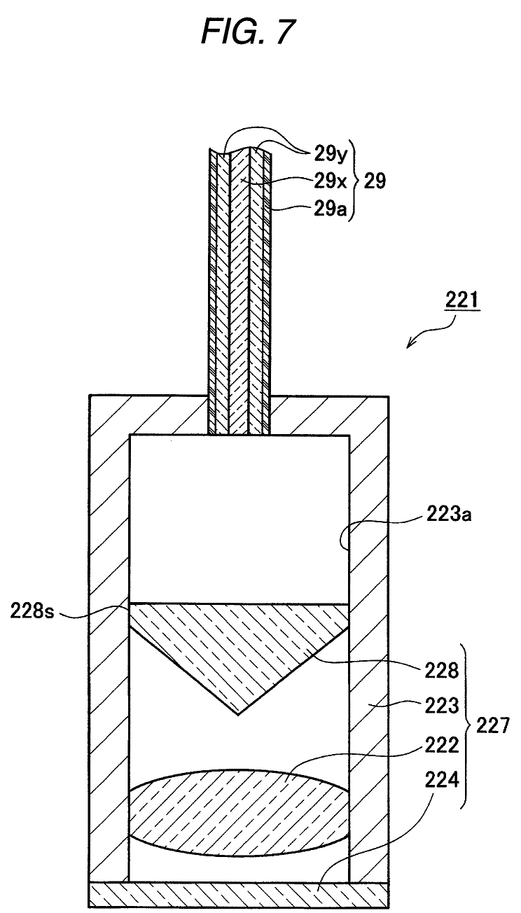

Referring to FIGS. 6 and 7, a second modification of the first exemplary embodiment will be described.

The second modification is different from the first exemplary embodiment in that a conical lens 228 is used to condense laser beams LB3 in a circular ring shape.

Therefore, the descriptions will be focused on different constructions from those of the first exemplary embodiment. Further, the descriptions of the same constructions as those of the first exemplary embodiment are omitted or simplified, but the same operational effect will be obtained for the same constructions. Further, like reference numerals will be attached to the same components.

A laser ignition device 220 of an engine 201 according to the second modification has a laser beam generator 28 which emits laser beams LB3 with a BPP value of 20 mm·mrad (radius·half angle) or less. In addition, the laser ignition device 220 includes an optical fiber 29 and a condenser 227 which compose a distribution-type condensing optical member 221. The condenser 227 includes a cylindrical casing 223, a convex lens 222, a protective glass 224, and a conical lens 227 (refer to FIG. 7).

The conical lens 227 is fixed to the casing 223 such that both lens side surfaces 228s thereof are bonded to the inner side surface 223a of the casing 223. The conical lens 228 changes cylindrical laser beams, incident from the optical fiber 29, into ring-shaped laser beams LB3 to emit toward the convex lens 222. The convex lens 222 condenses the laser beams LB3.

In the laser ignition device 220 and the engine 201 according to the second modification, the laser beams LB3 can be condensed in a ring shape on a focal position FP3 in the vicinities of the center of the combustion chamber 50 (refer to FIG. 6).

As such, in the laser ignition device 220 and the engine 201 according to the second modification, the laser beams LB3 can be condensed in a ring shape within the combustion chamber 50. Thus, it is possible to ignite fuel particles 60 across a wider range within the combustion chamber 50 than in the first exemplary embodiment. Therefore, the fuel particles 60 can be more uniformly and rapidly ignited. In the engine 201 using the laser ignition device 220 according to the second modification, it is possible to obtain a more proper combustion characteristic.

### 2. Second Exemplary Embodiment

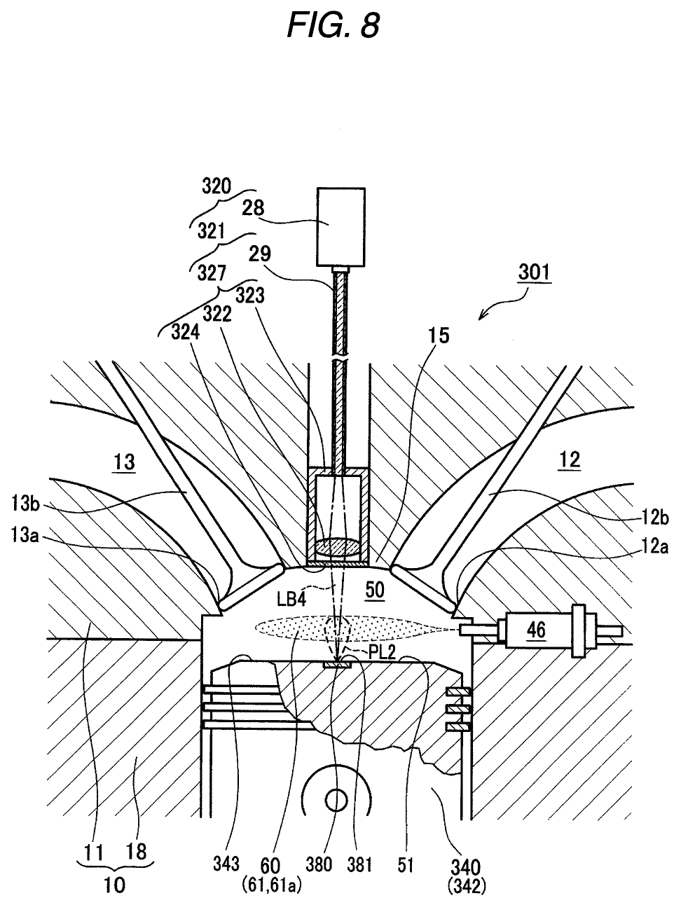

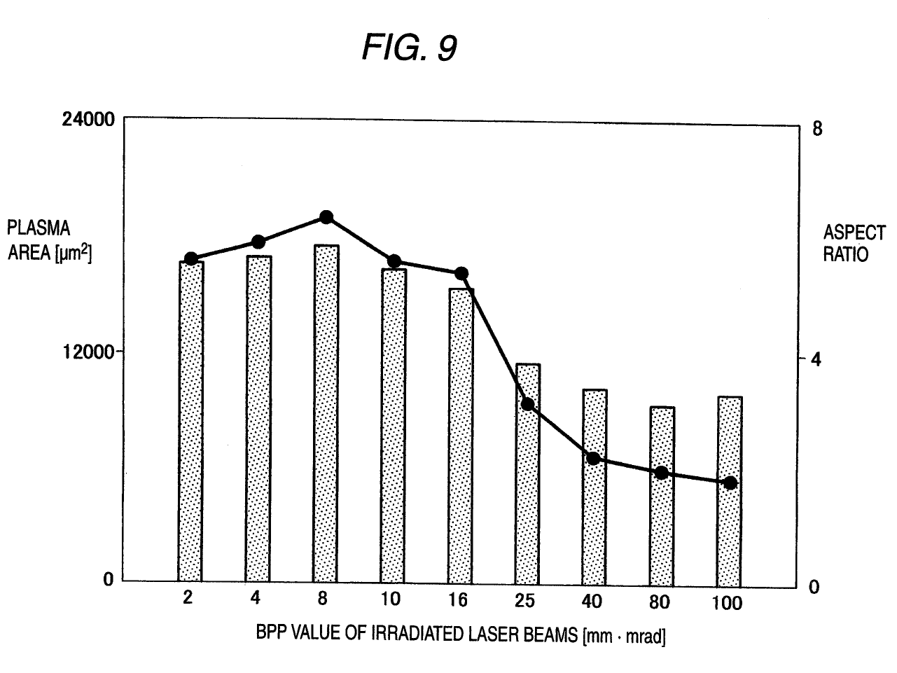

Referring to FIGS. 8 and 9, a second exemplary embodiment of the invention will be described.

The second exemplary embodiment is different from the first exemplary embodiment in that a focal position of laser beams is not formed in a space within the combustion chamber 50, but the laser beams are condensed on an irradiated surface 381 of a head surface 343 of a piston 340.

Therefore, the descriptions will be focused on different constructions from those of the first exemplary embodiment. Further, the descriptions of the same constructions as those of the first exemplary embodiment are omitted or simplified, but the same operational effect will be obtained for the same constructions. Further, like reference numerals will be attached to the same components.

The piston 340 of an engine 301 according to the second exemplary embodiment of the invention includes an irradiated body 380 which is composed of Ni-based heat-resistant alloy and is formed in a tip shape. The irradiated surface 381 of the irradiated body 380 forms a portion of the head surface 343 of the piston head 342, the head surface 343 forming a portion of a combustion chamber surface 51 of the combustion chamber 50. Further, a laser ignition device 320 composed of the laser beam generator 28 and a condensing optical member 321 has a condenser 327 (protective glass 324) exposed to the combustion chamber 50 from the top portion 15 of the cylinder 11, like the laser ignition device 20 of the first exemplary embodiment. Further, a convex lens 322 is fixed inside a casing 323 of the condenser 327. The focus of the convex lens 322 is adjusted so as to be positioned on the irradiated surface 381 at such timing that the piston 340 is positioned in the top dead center or in the vicinities of the top dead center.

In the engine 301 according to the second exemplary embodiment, the laser beam generator 28 which emits laser beams LB4 with a BPP value of 20 mm·mrad (radius·half angle) or less is also used. Therefore, although the convex lens 322 with a long focal distance is used, it is possible to properly condense the laser beams on the irradiated surface 381. Accordingly, when the laser beams LB4 are irradiated on the irradiated surface 381 of the head surface 343 of the piston 340 at such timing that the piston 340 is positioned at the top dead center or in the vicinities of the top dead center, a portion of the irradiated surface 381 corresponding to a focus is heated to high temperature such that plasma PL2 is highly blown up as shown in FIG. 8. When the plasma PL2 reaches a group 61 of fuel particles 60 injected from the injector 46, the fuel particles 60 can be ignited.

In the engine 301 according to the second exemplary embodiment, since the laser beams LB4 with a small BPP value are used, the plasma can be blown up more highly and widely than when a laser beams with a large BPP value are used. Accordingly, even the fuel particles 60 (the fuel particle group 61) in the vicinities of the center of the combustion chamber 50 can be ignited. That is, the fuel particles 60 can be ignited across a wide range, which makes it possible to obtain a more proper combustion characteristic.

Further, since the laser beams LB4 with a small BPP value are used, the focal distance of the convex lens 322 can be lengthened to enlarge the Rayleigh length. Therefore, although the irradiation timing of the laser beams LB4 is changed depending on the operation state of the engine 301, the plasma PL2 can be reliably discharged from the irradiated surface 381 of the piston 340, and the timing of ignition period can be easily adjusted.

Meanwhile, the present inventors carried out an experiment of verifying the relationship between a generated amount of plasma and a difference in BPP value by suing the laser ignition device 320 according to the second exemplary embodiment.

An irradiated body was disposed within a chamber pressurized at 0.1 MPa, and laser beams were irradiated on the surface (irradiated surface) of the irradiated body from outside, with the surface being set to a focus. At this time, plasma generated by the emission of the laser beams was photographed by a camera from outside, and the area of the plasma and an aspect ratio were quantitatively evaluated.

In this experiment, a laser beam generator which emits laser beams LB4 with total 9 kinds of BPP values, that is, 2, 4, 8, 10, 16, 25, 40, 80, and 100 mm·mrad (radius·half angle) toward the convex lens 322 was used as the laser beam generator 28 so as to carry out experiments for the respective values. Further, the irradiated body is formed of Ni-based heat-resistant alloy, a spot diameter is set to φ0.2 mm, and the laser energy of YAG lasers to be used was set to 400 mJ.

FIG. 9 is a graph showing the relationships among the BPP value of the used laser beams LB4, the area of the generated plasma (bar graph, left axis), and the aspect ratio (line graph, right axis). According to the graph, when the laser beams LB4 having a larger BPP value than 20 mm·mrad (radius·half angle) are used, the area of generated plasma is about 9000 μm² or less. On the contrary, it is judged that when laser beams having a smaller BPP value than 20 mm·mrad (radius·half angle) are used, the area of plasma can be considerably increased to 15000 μm². Further, when the laser beams LB4 having a larger BPP value than 20 mm·mrad (radius·half angle) are used, the aspect ratio is about 2-3. On the contrary, it is judged that when the laser beams LB4 having a larger BPP value than 20 mm·mrad (radius·half angle) are used, the aspect ratio is considerably increased to 5-6.

Meanwhile, when laser beams are condensed and irradiated on the metal surface (irradiated surface), plasma is blown up, and fuel particles coming in contact with the plasma are ignited and combusted by the high-temperature heat of the plasma. At this time, as the blown plasma broadens, a quantity of fuel particles coming in contact with the plasma increases. Accordingly, a larger quantity of fuel particles is ignited, and the combustion quickly propagates. Further, when the plasma is highly blown up, even the fuel particles 60 (fuel particle group 61) in a portion separated from the focal position, for example, in the central portion of the combustion chamber 50 can be ignited.

According to the effect of the above-described experiment, when the laser beams having a BPP value of 20 mm·mrad (radius·half angle) or less are used, the generation range of the plasma is much wider and the plasma is blown up much highly than when laser beams having a larger BPP value than 20 mm·mrad (radius·half angle) are used. Accordingly, it is judged that when the laser beam generator 28 which emits the laser beams LB4 having a BPP value of 20 mm·mrad (radius·half angle) or less is used in the laser ignition device 320 according to the second exemplary embodiment, the ignition and combustion can be more quickly and stably realized.

The present invention has been described by exemplifying the first and second exemplary embodiments and the first and second modifications. However, the invention is not limited to the exemplary embodiments and modifications, but various changes and modifications in form and detail may be made therein without departing from the scope of the present invention.

For example, in the second exemplary embodiment, although the irradiated surface is provided on the head surface of the piston head, any one of combustion chamber side surfaces constructing the combustion chamber may be used as the irradiated surface. Further, in the first exemplary embodiment, although the laser beams are condensed on two focal points, the laser beams may be condensed on three or more focal points. Furthermore, in the second modification, although the laser beams are condensed in a ring shape, the laser beams may be condensed in a proper shape such as an elliptical shape or a line segment shape.

It should further be apparent to those skilled in the art that various changes in form and detail of the invention as shown and described above may be made. It is intended that such changes be included within the spirit and scope of the claims appended hereto.

What is claimed is:

1. A laser ignition device for irradiating and condensing laser beams in a combustion chamber of an internal combustion engine so as to ignite fuel particles within the combustion chamber, the laser ignition device comprising:
a laser beam generating unit for emitting the laser beams; and
a condensing optical member for guiding the laser beams into the combustion chamber such that the laser beams are condensed in the combustion chamber,
wherein the laser beam generating unit comprises a Beam Parameter Product (BPP) laser beam generating unit which emits the laser beams with a BPP value of no more than 20 mm·mrad (radius·half angle).

2. The laser ignition device according to claim 1, wherein the condensing optical member is a distribution-type condensing optical member which condenses the laser beams in the combustion chamber such that the laser beams are distributed in a line shape or dotted shape.

3. The laser ignition device according to claim 1, wherein a movement distance of a focal position of the laser beams within the combustion chamber is no less than 40 mm.

4. A laser-ignition internal combustion engine comprising:
an internal combustion engine comprising a combustion chamber; and
a laser ignition device which irradiates and condenses laser beams in the combustion chamber of the internal combustion engine so as to ignite fuel particles within the combustion chamber, the laser ignition device comprising:
a laser beam generating unit for emitting the laser beams; and
a condensing optical member for guiding the laser beams into the combustion chamber such that the laser beams are condensed in the combustion chamber,
wherein the laser beam generating unit comprises a Beam Parameter Product (BPP) laser beam generating unit which emits the laser beams with a BPP value of no more than 20 mm·mrad (radius·half angle).

5. The laser-ignition internal combustion engine according to claim 4, wherein the fuel particles are introduced into the combustion chamber in a particle group movement path, and wherein the condensing optical member provides that the laser beams guided into the combustion chamber by the optical member pass through the particle group movement path.

6. The laser-ignition internal combustion engine according to claim 4, wherein the condensing optical member is a distribution-type condensing optical member which condenses the laser beams in the combustion chamber such that the laser beams are distributed in a line shape or dotted shape.

7. The laser-ignition internal combustion engine according to claim 4,
wherein the combustion chamber includes a combustion chamber surface having an irradiated surface portion made of metal, and
wherein the condensing optical member condenses the laser beams on the irradiated surface portion.

8. The laser-ignition internal combustion engine according to claim 7,
wherein the internal combustion engine further comprises a piston which reciprocates in a cylinder bore of the internal combustion engine, the piston comprising a piston combustion-chamber side surface forming a portion of the combustion chamber surface, the piston combustion-chamber side surface comprising the irradiated surface portion, and
wherein the condensing optical member condenses the laser beams on the irradiated surface portion when the piston is positioned at least close to a top dead center position.

9. The laser-ignition internal combustion engine according to claim 4, wherein a movement distance of a focal position of the laser beams within the combustion chamber is no less than 40 mm.

10. The laser-ignition internal combustion engine according to claim 5, wherein the particle group movement path extends in a first direction and the laser beams are irradiated in a second direction, and the first and second directions are separated by an angle of between 30 and 150 degrees.
